(19) United States
(12) Patent Application Publication
(10) Pub. No.: US 2015/0321779 A1
(43) Pub. Date: Nov. 12, 2015

(54) Crimper For Metal Seals

(71) Applicant: Encore Packaging LLC, Lake Bluff, IL (US)

(72) Inventors: Timothy H. Nelson, Winnetka, IL (US); Roberto Garces, Des Plaines, IL (US)

(21) Appl. No.: 14/707,641

(22) Filed: May 8, 2015

Related U.S. Application Data
(60) Provisional application No. 62/072,597, filed on Oct. 30, 2014.
(60) Provisional application No. 61/990,444, filed on May 8, 2014.

(51) Int. Cl. B65B 13/34; B25B 27/14

(52) U.S. Cl. CPC B65B 13/345; B25B 27/146

(57) ABSTRACT

A metal seal crimping tool includes a one or more of a variety of modifications to facilitate an improved rate of quality seals made through crimping metal seals, for example, around strapping. One such modification includes shaping and mounting opposing jaws in the crimping tool to overlap by cutting out matching portions of the jaw tips so that the opposing jaws can interlace. Another modification includes having a rounded jaw-seal engagement profile portion that transitions to a flat portion. The rounded jaw-seal engagement portion is disposed to bend the short flange of the metal seal, and the flat portion is disposed to compress a long edge of the metal seal during the crimping process. Another modification includes having lateral extensions on tips of the jaws disposed on outer portions of the crimper tool to extend the reach of the tool further to the ends of the metal seal.

### RELATED APPLICATIONS

This application claims the benefit of U.S. provisional patent application No. 62/072,597 filed Oct. 30, 2014, and U.S. provisional patent application No. 61/990,444 filed May 8, 2014, both of which are incorporated by reference herein in their entireties.

### TECHNICAL FIELD

The invention relates generally to the packaging industry and, more specifically, to crimping tools for closing metal seals to lock strapping around a secured object.

### BACKGROUND

Metal seals, both smooth and serrated, are known and used for securing strapping around an object, for example, for securing an object to a pallet for shipping. The strapping is typically a flat metal or plastic strap less than an inch wide. The seal is typically a metal seal that is crimped around two ends of the strap, in effect tying the two ends together in securing the strap to an object. A common metal seal includes a main body having a width sized to receive the strapping's width. The seal also includes a short flange extending from the main body and a long flange extending from the main body. A crimping tool pinches the long flange toward the strapping and main body to lock the strapping within the thusly closed seal. The crimping tool also folds the short flange over the end of the long flange during the crimping process.

Known crimping tools for metal seals use a plurality of jaws mounted to rotate with movement of a handle. An example known crimping tool is illustrated in FIG. 1. The jaws have a profile edge that engages the short and long flanges to bend them in closing the metal seal. The typical crimping tool must be used in a proper orientation relative to the metal seal. In other words, one side of the crimping tool holds jaws with a longer tip designed to engage and close the long flange, and the other side of the crimping tool holds jaws with a shorter tip designed to engage and close the short flange. Where users apply seals and tools without focus or at high speed, the seal may be inserted into the crimping tool with a wrong orientation, potentially compromising the resulting sealing of the strapping, which could allow the strapping to slip at an undesirably low force.

Attempts to produce a metal seal crimping tool that is agnostic with respect to orientation of insertion of the metal seal into the crimping tool have been made. In one approach, a highly specific profile edge used to engage the flange was used in combination with offsetting the jaws so that opposing jaws do not align. A different approach is described with this disclosure.

### SUMMARY

Generally speaking and pursuant to these various embodiments, a metal seal crimping tool includes a one or more of a variety of modifications to facilitate an improved rate of quality seals made through crimping metal seals, for example around strapping. One such modification includes shaping and mounting opposing jaws in the crimping tool to overlap by cutting out or machining away matching portions of the jaw tips so that the opposing jaws can interlace or interlock. The interlocked arrangement allows for a crimping force to be applied completely across the metal seal. Another modification includes having a rounded jaw-seal engagement profile portion that transitions to a flat portion. The rounded jaw-seal engagement portion is disposed to bend the short flange of the metal seal, and the flat portion is disposed to compress a long edge of the metal seal during the crimping process. Such a configuration has shown an improved ability to handle both short and long flanges of the metal seal regardless of the orientation of the seal relative to the crimping tool. Another modification includes having lateral extensions on tips of the jaws disposed on outer portions of the crimper tool to extend the reach of the tool further to the ends of the metal seal, which provides a further crimping effect.

These and other benefits may become clearer upon making a thorough review and study of the following detailed description.

### BRIEF DESCRIPTION OF THE DRAWINGS

The above needs are at least partially met through provision of the crimper for metal seals described in the following detailed description, particularly when studied in conjunction with the drawings, wherein:

FIG. 1 comprises a perspective exploded view of an example prior art metal seal crimping tool;

FIG. 2 comprises a perspective view of a crimping end of a metal seal crimping tool using outer jaws configured in accordance with various embodiments of the invention;

FIG. 3 comprises a top view of a metal seal crimping tool using inner jaws having cut out portions to facilitate an interlocking arrangement as configured in accordance with various embodiments of the invention;

FIG. 4 comprises a set of engineering drawings of an example jaw with a jaw-seal engagement portion profile configured in accordance with various embodiments of the invention;

FIG. 5 comprises a set of engineering drawings of an example jaw with a jaw-seal engagement portion profile and angled end portion configured in accordance with various embodiments of the invention;

FIG. 6 comprises a set of engineering drawings of another example jaw with a jaw-seal engagement portion profile and angled end portion configured in accordance with various embodiments of the invention;

FIG. 7 comprises a perspective top view of a crimping end of a metal seal crimping tool using outer jaws with angled end portions configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

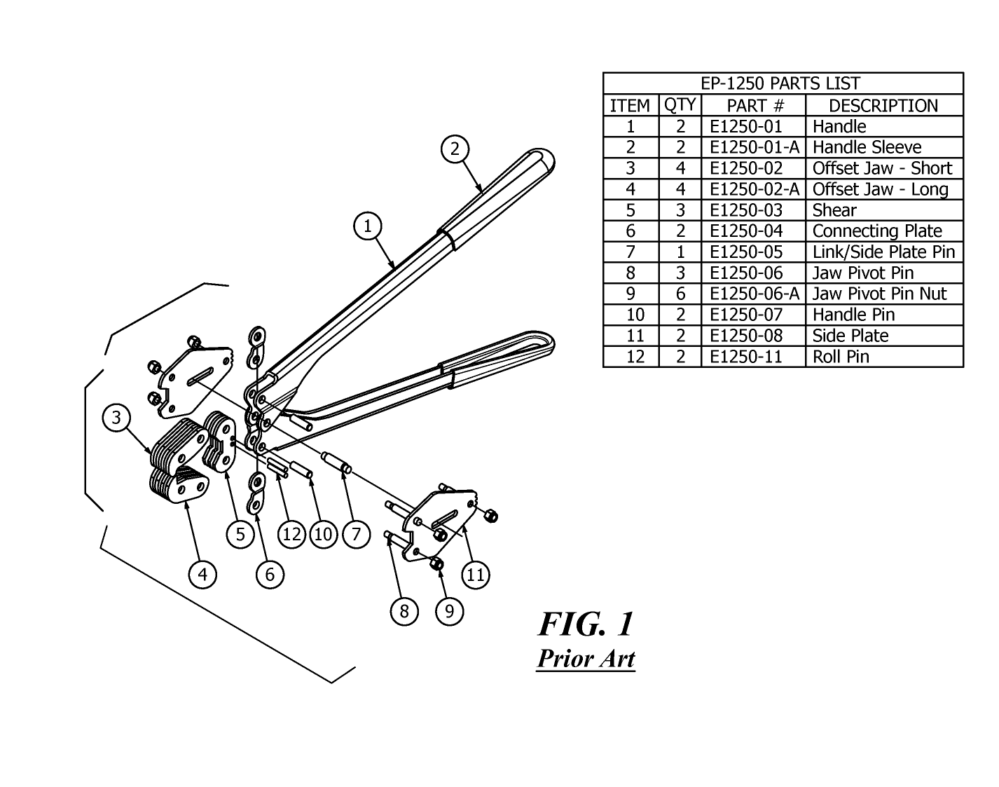

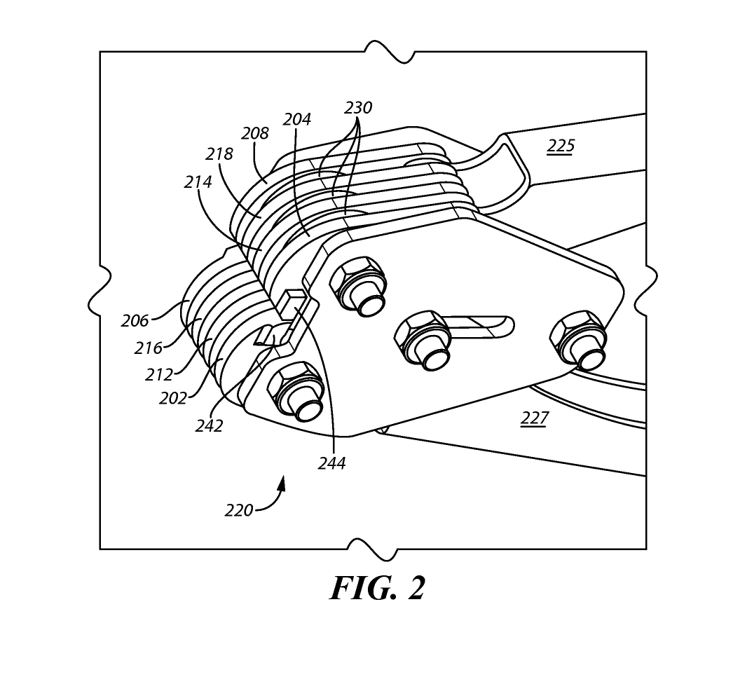

Referring now to the drawings and, in particular to FIGS. 1 and 2 an example apparatus for clamping a metal seal will be described. FIG. 1 illustrates a known crimping tool for metal seals. The jaws 3 and 4 of FIG. 1 can be replaced with jaws described below to create a new crimping tool without modifying any of the rest of the crimping tool of FIG. 1. FIG. 2 illustrates one such example. A plurality of jaw units 202, 204, 206, 208, 212, 214, 216, and 218 are mounted in a metal seal crimper 220 to move in response to a movement of a handle 225, 227 of the metal seal crimper 220 to close a metal seal disposed within the metal seal crimper 220. More specifically, the metal seal is placed in the crimper with the main body resting against the shear elements 230 with the handle in an open position.

FIG. 2 illustrates the crimper with the jaw units 202, 204, 206, 208, 212, 214, 216, and 218 in a closed position in which the metal seal would be closed around the secured strapping. For instance, a first opposing pair 212 and 214 of the plurality of jaw units are mounted to close toward each other during the movement of the handle 225, 227 to overlap across the metal seal during closing. In one approach, the first opposing pair 212 and 214 of jaw units have a same jaw-seal engagement portion profile. A second opposing pair 202 and 204 of the plurality of jaw units are mounted at an outer portion of the metal seal crimper 220 and to close toward each other during the movement of the handle 225, 227. At least one of the second opposing pair 202 and 204 of jaw units includes an extension 242, 244 extending away from an inner portion of the metal seal crimper 220 and coextensive with a portion of a jaw-seal engagement portion to engage an outer edge of a metal seal. So configured, the crimper can pinch along more if not all of the length of the metal seal as compared to known metal seal crimping tools, improving the folding of the ends of the metal seal during the crimping process. This additional crimping can improve overall gripping of the strapping by the seal.

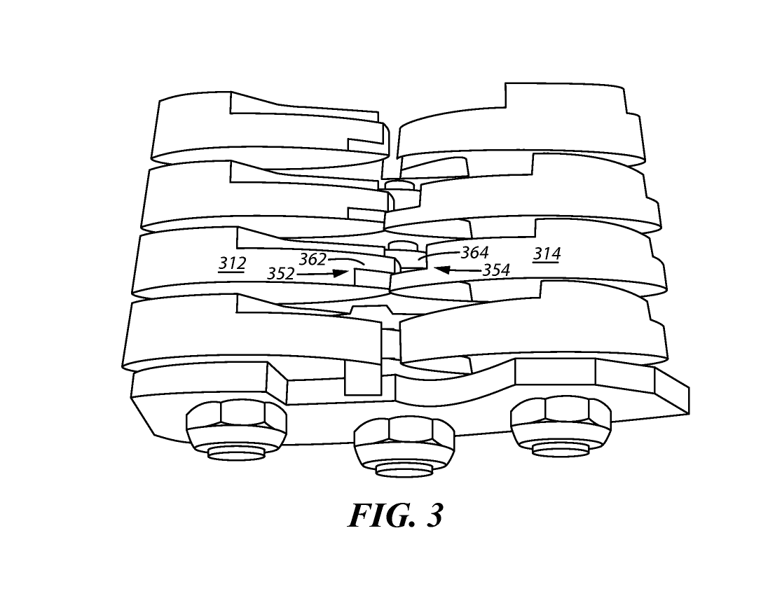

FIG. 3 illustrates another aspect where opposing jaws may include cut out portions to facilitate an overlapping/interlocking of the jaws to increase a surface of the metal seal engaged by the jaws during crimping. More specifically, each of the first opposing pair 312 and 314 of the plurality of jaw units includes an end portion 352 and 354 having a cut out 362 and 364. The cut out 362 of a first jaw unit 312 of the first opposing pair corresponds to the cut out 364 of the second jaw unit 314 such that the end portion 352 of first jaw unit 312 and the end portion 354 of the second jaw unit 314 interlock to effect the overlap across the metal seal during closing.

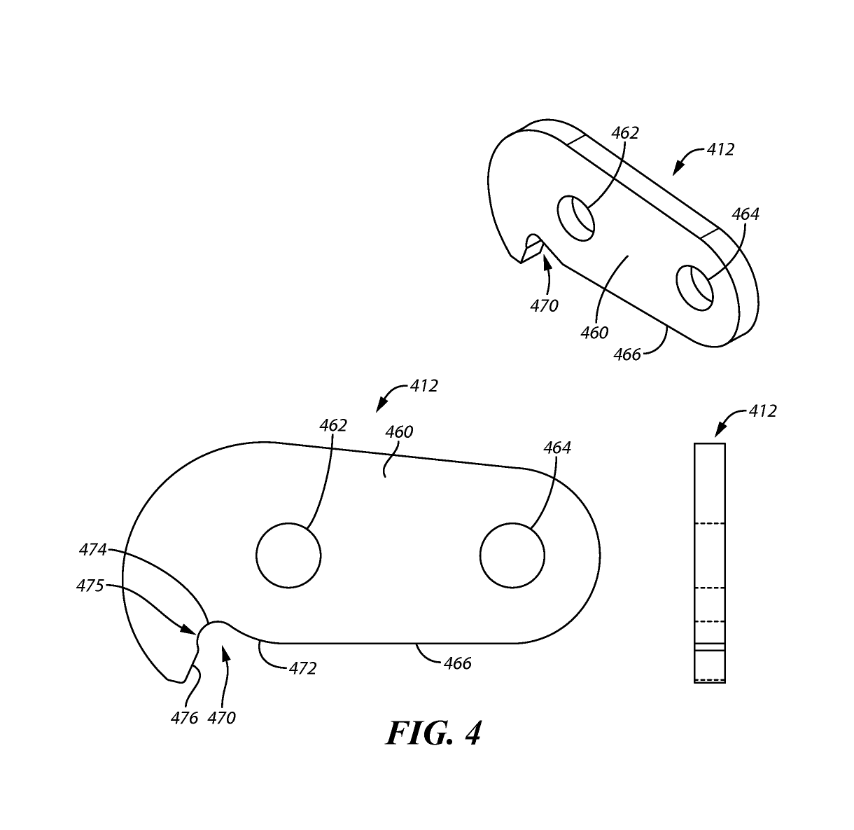

FIG. 4 illustrates a still further aspect. The illustrated example jaw 412 has a body section 460 configured to be secured to the metal seal crimper via the through holes 462 and 464. The body 460 has an inside edge 466 leading to the jaw-seal engagement portion 470. The inside edge 466 bends inward toward the body following a first and inward curve 472. The first and inward curve 472 transitions to a second and outward curve 474 away from the body 460 that follows an outward curve radius. The second and outward curve 474 transitions to a flat portion 476 disposed to compress a long edge of the metal seal during the movement of the handle of the crimping tool in which the jaw 412 is mounted. In one aspect, when the jaw 412 is disposed in a closed position in the metal seal crimper, at least a portion 475 of the second and outward curve 474 extends farther away from the metal seal than the flat portion 476. This curling of the jaw downward toward the metal seal before transitioning to the flat portion 476 helps facilitate rolling over the lips of the metal seal ends, in particular the short flange end to be pinched over the long flange. So configured, a metal seal can be more reliably crimped around a set of strapping to seal and secure the strapping regardless of the orientation of the metal seal's short and long flanges with respect to particular jaws of the metal crimper. Accordingly, the risk of a seal or strapping failure caused by a user error in aligning a seal's short flange with particular jaws is reduced.

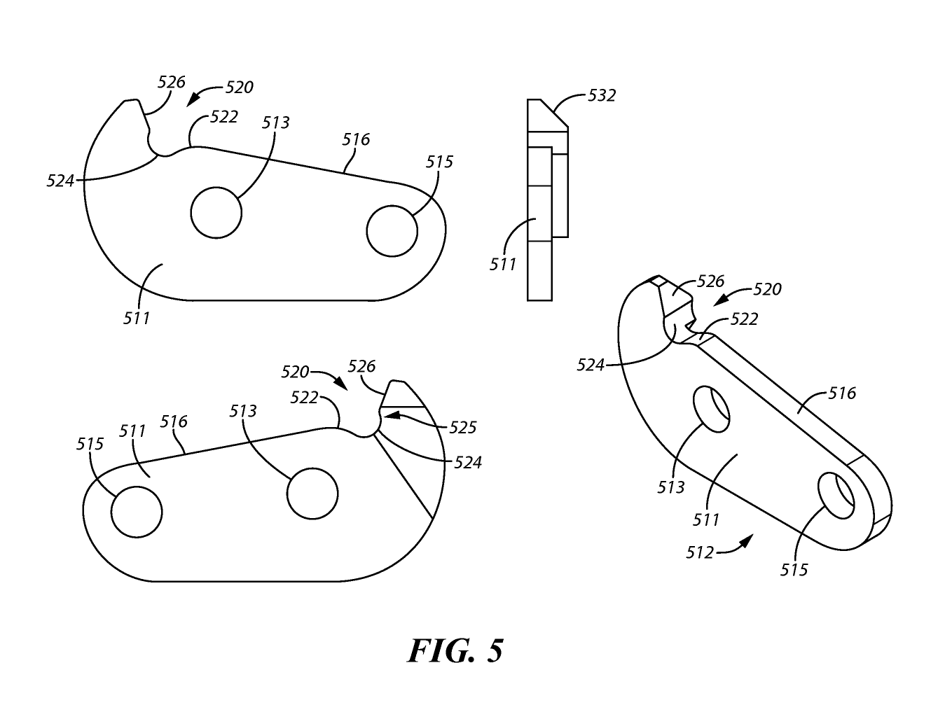

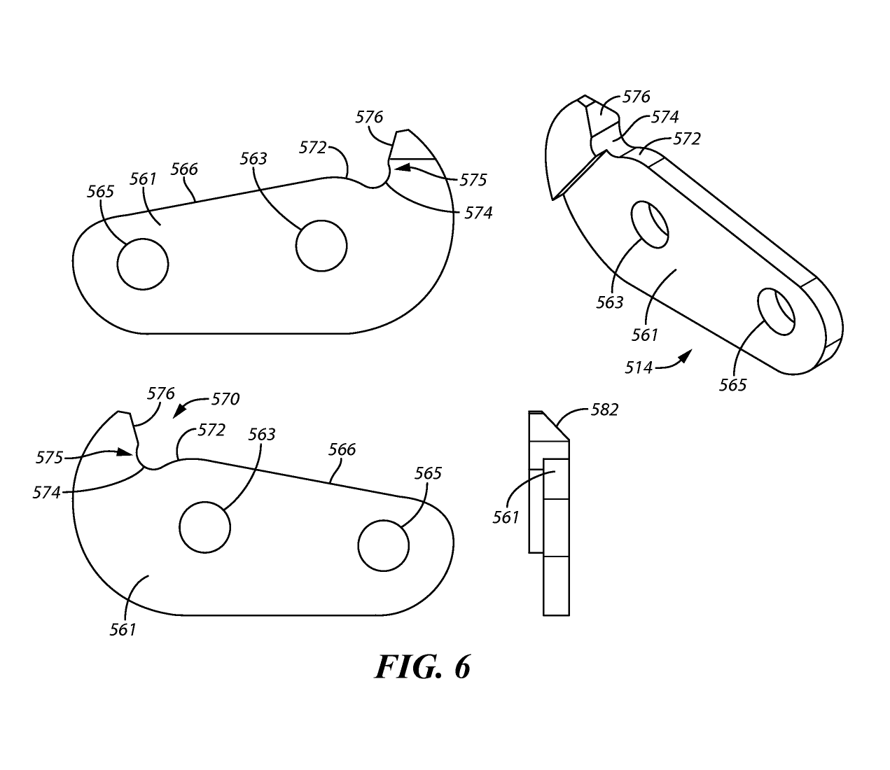

Another example jaw design that effects overlap across the metal seal is illustrated in FIGS. 5-7. Here, instead of the jaw units having cut out portions to allow overlapping coverage over the metal seal, the jaw units have complimentary angled tips to allow the overlap. FIGS. 5 and 6 illustrate complimentary jaw units 512 and 514, respectively. The curved profile of the seal engaging portions of these jaw units 512 and 514 match that of the example jaw unit 412 illustrated in FIG. 4 above. Accordingly, FIG. 5 illustrates a jaw unit 512 with a body 511 having an inside edge 516 leading to the jaw-seal engagement portion 520. The inside edge 516 bends inward toward the body following a first and inward curve 522. The first and inward curve 522 transitions to a second and outward curve 524 away from the body 511 that follows an outward curve radius. The second and outward curve 524 transitions to a flat portion 526 disposed to compress a long edge of the metal seal during the movement of the handle of the crimping tool in which the jaw 512 is mounted. In one aspect, when the jaw 512 is disposed in a closed position in the metal seal crimper, at least a portion 525 of the second and outward curve 524 extends farther away from the metal seal than the flat portion 526. This curling of the jaw downward toward the metal seal before transitioning to the flat portion 526 helps facilitate rolling over the lips of the metal seal ends, in particular the short flange end to be pinched over the long flange. The end portion profile of the jaw 512 includes an angled end portion 532. The angled end portion 532 of the jaw 512 corresponds to an angled end portion of a second jaw unit of the opposing pair of jaws such that the end portions interlock to effect an overlap across the metal seal during closing.

FIG. 6 illustrates a jaw unit 514 complimentary to the jaw unit 512 of FIG. 5 such that they could form an opposing pair in a metal crimper. Like the jaw unit 512 of FIG. 5, the jaw unit 514 of FIG. 6 has a body 561 having an inside edge 566 leading to the jaw-seal engagement portion 570. The inside edge 566 bends inward toward the body following a first and inward curve 522. The first and inward curve 572 transitions to a second and outward curve 574 away from the body 561 that follows an outward curve radius. The second and outward curve 574 transitions to a flat portion 576 disposed to compress a long edge of the metal seal during the movement of the handle of the crimping tool in which the jaw 514 is mounted. In one aspect, when the jaw 514 is disposed in a closed position in the metal seal crimper, at least a portion 575 of the second and outward curve 574 extends farther away from the metal seal than the flat portion 576. This curling of the jaw downward toward the metal seal before transitioning to the flat portion 576 helps facilitate rolling over the lips of the metal seal ends, in particular the short flange end to be pinched over the long flange. The end portion profile of the jaw 514 includes an angled end portion 582. The angled end portion 582 of the jaw 514 corresponds to the angled end portion 532 of the jaw 512 of FIG. 5 such that jaw units 512 and 514 can comprise opposing jaw units in a metal seal in a configuration where the end portions 532 and 582 of the jaws 512 and 514 interlock to effect an overlap across the metal seal during closing.

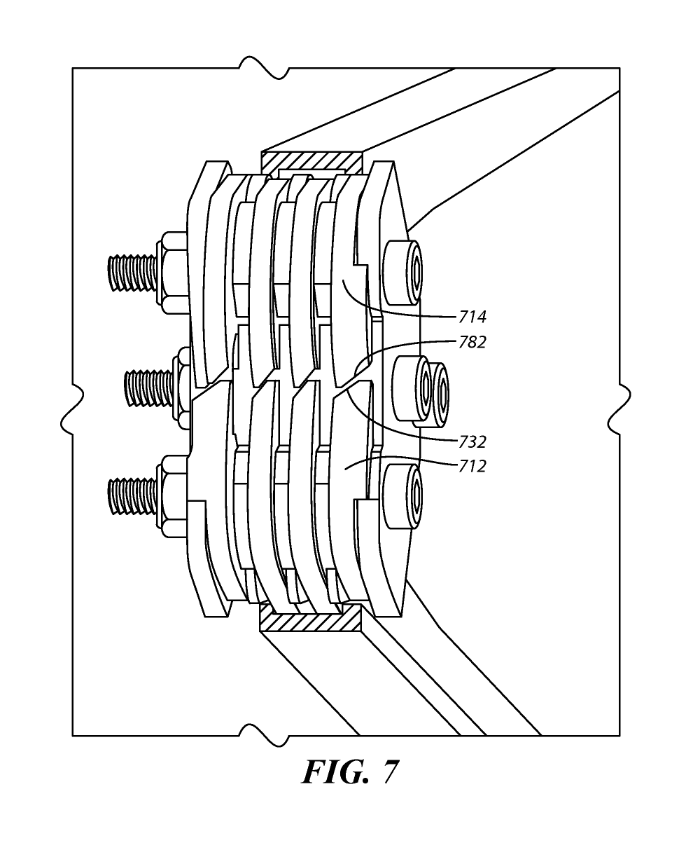

FIG. 7 illustrates an example metal seal crimper 701 using opposing jaw units 712 and 714 that comprise mirror images of those illustrated in FIGS. 5 and 6. FIG. 7 illustrates how the end portions of the jaw units 712 and 714 interlock to fully overlap across a metal seal when the metal seal crimper 701 is in a closed, sealing position. The angled end portions 732 and 782 of the respective jaw units 512 and 514 complement each other to effect the interlocking overlap across the metal seal. As illustrated in FIG. 7, all the jaw units can include angled end portions to facilitate the interlocking overlap across the metal seal. So configured, the metal seal is contacted across its full width during the crimping process thereby improving the folding of the ends of the metal seal during the crimping process. This additional crimping can improve overall gripping of the strapping by the seal.

Those skilled in the art will recognize that a wide variety of modifications, alterations, and combinations can be made with respect to the above described embodiments without departing from the scope of the invention. For instance, any of the above aspects can applied to a known metal seal crimping tool alone or in any combination to improve different aspects of the crimping tool's performance. Such modifications, alterations, and combinations are to be viewed as being within the ambit of the inventive concept.

What is claimed is:

1. An apparatus for clamping a metal seal, the apparatus comprising:
a plurality of jaw units mounted in a metal seal crimper to move in response to a movement of a handle of the metal seal crimper to close a metal seal disposed within the metal seal crimper;
a first opposing pair of the plurality of jaw units mounted to close toward each other during the movement of the handle to overlap across the metal seal during closing, wherein the first opposing pair of jaw units have a same jaw-seal engagement portion profile;
a second opposing pair of the plurality of jaw units mounted at an outer portion of the metal seal crimper and to close toward each other during the movement of the handle, wherein at least one of the second opposing pair of jaw units comprises an extension extending away from an inner portion of the metal seal crimper and coextensive with a portion of a jaw-seal engagement portion to engage an outer edge of a metal seal.

2. The apparatus of claim 1 wherein each of the first opposing pair of the plurality of jaw units comprises an end portion having a complimentary end portion profile, wherein the complimentary end portion profile of a first jaw unit of the first opposing pair corresponds to the complimentary end portion profile of the second jaw unit of the second opposing pair such that the end portions of first jaw unit and the second jaw unit interlock to effect the overlap across the metal seal during closing.

3. The apparatus of claim 2 wherein the complimentary end portion profiles of the first opposing pair of the plurality of jaw units comprise cut outs, wherein the cut out of a first jaw unit of the first opposing pair corresponds to the cut out of the second jaw unit of the second opposing pair such that the end portions of first jaw unit and the second jaw unit interlock to effect the overlap across the metal seal during closing.

4. The apparatus of claim 2 wherein the complimentary end portion profiles of the first opposing pair of the plurality of jaw units comprise angled end portions, wherein the angled end portions of a first jaw unit of the first opposing pair corresponds to the angled end portions of the second jaw unit of the second opposing pair such that the end portions of first jaw unit and the second jaw unit interlock to effect the overlap across the metal seal during closing.

5. The apparatus of claim 1 wherein the jaw-seal engagement portion profile comprises a body section secured to the metal seal crimper, the body having an inside edge leading to the jaw-seal engagement portion,
wherein the inside edge bends inward toward the body following a first and inward curve,
wherein the first and inward curve transitions to a second and outward curve away from the body that follows an outward curve radius;
wherein the second and outward curve transitions to a flat portion disposed to compress a long edge of the metal seal during the movement of the handle.

6. The apparatus of claim 5 wherein when the first opposing pair is disposed in a closed position in the metal seal crimper after movement toward each other during closing, at least a portion of the second and outward curve extends farther away from the metal seal than the flat portion.

7. An apparatus for clamping a metal seal, the apparatus comprising:
a plurality of jaw units mounted in a metal seal crimper to move in response to a movement of a handle of the metal seal crimper to close a metal seal disposed within the metal seal crimper;
a first opposing pair of the plurality of jaw units mounted to close toward each other during the movement of the handle to overlap across the metal seal during closing, wherein the first opposing pair of jaw units have a same jaw-seal engagement portion profile;
wherein each of the first opposing pair of the plurality of jaw units comprises an end portion having a cut out, wherein the cut out of a first jaw unit of the first opposing pair corresponds to the cut out of the second jaw unit of the second opposing pair such that the end portions of first jaw unit and the second jaw unit interlock to effect the overlap across the metal seal during closing.

8. The apparatus of claim 7 jaw-seal engagement portion profile comprises a body section secured to the metal seal crimper, the body having an inside edge leading to the jaw-seal engagement portion,
wherein the inside edge bends inward toward the body following a first and inward curve,
wherein the first and inward curve transitions to a second and outward curve away from the body that follows an outward curve radius;
wherein the second and outward curve transitions to a flat portion disposed to compress a long edge of the metal seal during the movement of the handle.

9. The apparatus of claim 8 wherein when the first opposing pair is disposed in a closed position in the metal seal crimper after movement toward each other during closing, at least a portion of the second and outward curve extends farther away from the metal seal than the flat portion.

10. An apparatus for clamping a metal seal, the apparatus comprising:
a plurality of jaw units mounted in a metal seal crimper to move in response to a movement of a handle of the metal seal crimper to close a metal seal disposed within the metal seal crimper;
a first opposing pair of the plurality of jaw units mounted to close toward each other during the movement of the handle to overlap across the metal seal during closing, wherein the first opposing pair of jaw units have a same jaw-seal engagement portion profile;
wherein the jaw-seal engagement portion profile comprises a body section secured to the metal seal crimper, the body having an inside edge leading to the jaw-seal engagement portion;
wherein the inside edge bends inward toward the body following a first and inward curve;
wherein the first and inward curve transitions to a second and outward curve away from the body that follows an outward curve radius;
wherein the second and outward curve transitions to a flat portion disposed to compress a long edge of the metal seal during the movement of the handle.

11. The apparatus of claim 10 wherein when the first opposing pair is disposed in a closed position in the metal seal crimper after movement toward each other during closing, at least a portion of the second and outward curve extends farther away from the metal seal than the flat portion.
